(19) United States
(12) Patent Application Publication
(10) Pub. No.: US 2025/0271275 A1
(43) Pub. Date: Aug. 28, 2025

(54) POPULAR ROUTE INFERENCE AND RECONSTRUCTION SYSTEM

(71) Applicant: Uber Technologies, Inc., San Francisco, CA (US)

(72) Inventors: Roozbeh Ketabi, Sunnyvale, CA (US); Salone Gupta, Sunnyvale, CA (US); Koushik Peri, Seattle, WA (US); Thommen Korah, San Ramon, CA (US)

(21) Appl. No.: 18/585,692

(22) Filed: Feb. 23, 2024

(51) Int. Cl. G01C 21/34

(52) U.S. Cl. CPC G01C 21/3484

(57) ABSTRACT

Example embodiments are directed to systems and methods for providing popular route inference and reconstruction. The system captures trip data of a plurality of users traversing routes by monitoring user devices of the plurality of users. The system then analyzes the trip data between an origin/destination (O/D) pair to determine candidate popular trips between the O/D pair comprising detours. Top-ranking waypoints of segments of the candidate popular trips are determined. The top-ranking waypoints of the O/D pair are stored in a waypoint data storage. In response to receiving a request for a transportation service between the O/D pair from a user, the system reconstructs a popular route using the top-ranking waypoints and causes presentation on a user device of the user of a plurality of route options for selection by the user including the reconstructed popular route.

### TECHNICAL FIELD

The subject matter disclosed herein generally relates to navigation. Specifically, the present disclosure addresses systems and methods that identify popular routes based on analysis of traversed segments of past routes and reconstructs popular routes in real-time based on the most popular segments.

### BACKGROUND

Conventionally, one or more routes may be suggested to a user upon a request for transportation service or a navigation request from an origin to a destination. In some cases, popular routes between the origin and destinations may be stored in full and presented upon request. However, such stored routes are very restrictive and not configurable when situations where traffic or other slowdowns (e.g., road work, rush hour) are present.

### BRIEF DESCRIPTION OF THE DRAWINGS

Some embodiments are illustrated by way of example and not limitation in the figures of the accompanying drawings.

FIG. 1 is a diagram illustrating a network environment suitable for providing popular route inference and reconstruction, according to example embodiments.

FIG. 2 is a block diagram illustrating components of a network system for inferring popular routes and reconstructing a popular route in real-time based on segments of the inferred popular routes, according to example embodiments.

FIG. 3 is a flowchart illustrating operations of a method for inferring and reconstructing popular routes, according to example embodiments.

FIG. 4 is a flowchart illustrating operations of a method for analyzing trip data to determine top trips and top detour segments, according to example embodiments.

FIG. 5 is a flowchart illustrating operations of a method for identifying top waypoints, according to example embodiments.

FIG. 6 is a flowchart illustrating operations of a method for presenting route recommendations including a reconstructed popular route, according to example embodiments.

FIG. 7 is a block diagram illustrating components of a machine, according to some example embodiments, able to read instructions from a machine-storage medium and perform any one or more of the methodologies discussed herein.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components) are optional and may be combined or subdivided, and operations (e.g., in a procedure, algorithm, or other function) may vary in sequence or be combined or subdivided.

In a transportation service, riders and/or drivers may be presented with multiple routes from an origin to a destination from which they can select to navigate. The multiple routes can include, for example, a fastest route, a cheapest route, a shortest route, and a most fuel-efficient route. Sometimes the fastest route may not be the shortest route (e.g., during rush hour going through a city-center may be slower than going around the city-center) or the cheapest route. Other routes can be considered that are not common. Some of these routes are surfaced to riders for selection when establishing a transportation service.

Example embodiments are directed to determining popular routes between an origin and a destination. In some examples, a popular route is not a primary route and is reconstructed in real-time based on real-time conditions, such as traffic conditions or time of day. A primary route is defined as a typically recommended and traversed route, such as a fastest route or a shortest distance route. Specifically, example embodiments infer popular routes, identify segments of these inferred popular routes, and determine the most popular segments indicated by the most traversed segments between the origin and destination. In some examples, the segments include detours taken off of a primary route. Subsequently, when a request for a route is received, the system determines current conditions, for example, based on the time of the request, and reconstructs a popular route based on the current conditions and the popular segments via their corresponding waypoints. In example cases, a waypoint is a point of reference or location that can be used to define a navigation route. The reconstructed popular route and other routes, such as a primary route or a route to avoid any freeways, are presented to the rider for selection.

Selection and navigation of these routes is monitored and used as feedback for refining future popular route segments, their corresponding waypoints, and future popular route reconstruction. In some embodiments, the analysis is performed using one or more machine learning models trained, by the network system, based on past selected and traversed segments and routes, and selection and navigation of recommended routes is monitored and used as feedback for retraining the one or more machine learning models.

As such, the present disclosure provides technical solutions for determining popular routes between an origin and a destination and reconstructing popular routes in real-time based on real-time conditions. Therefore, one or more of the methodologies described herein facilitate solving the technical problem of providing navigation information tailored to real-time conditions in a networked environment for providing services such as a ride sharing service, food or item delivery service, or the like.

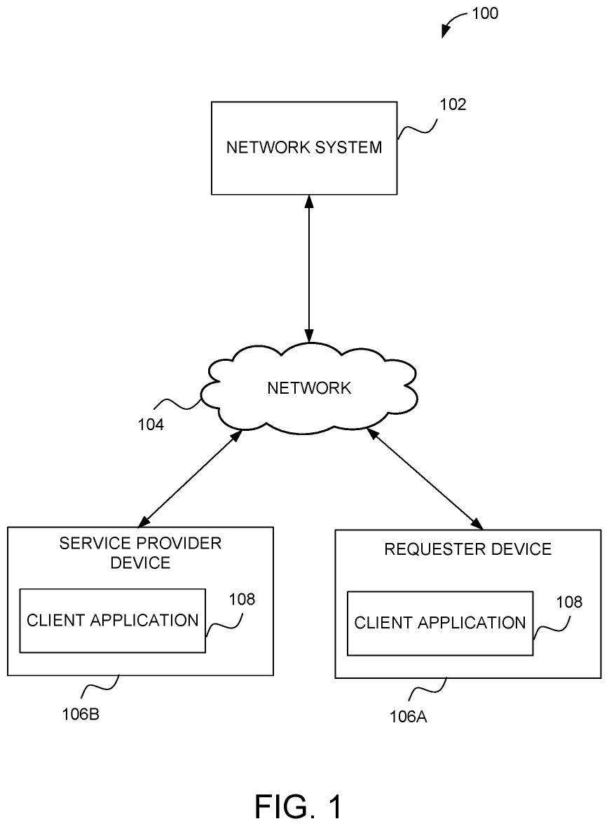

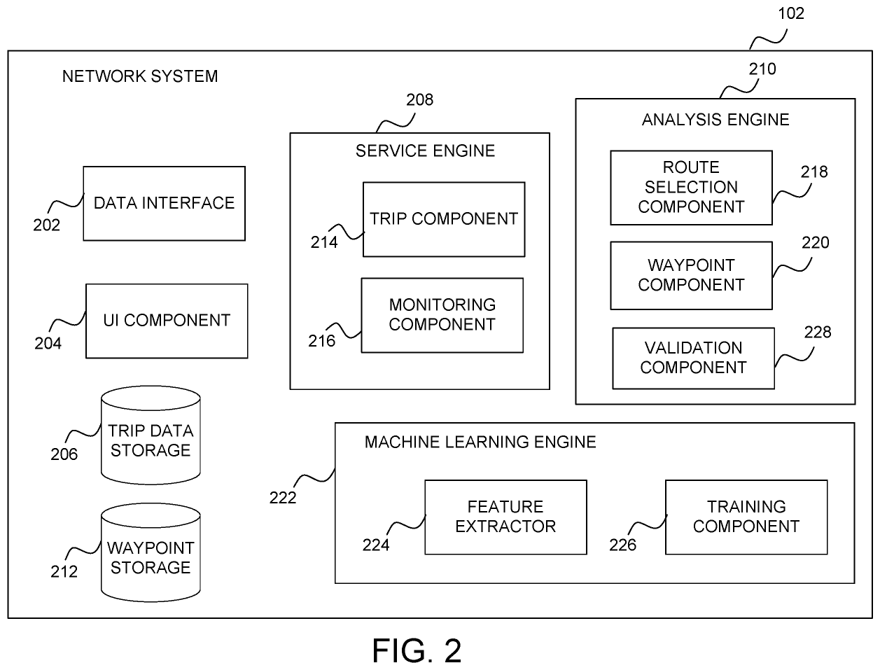

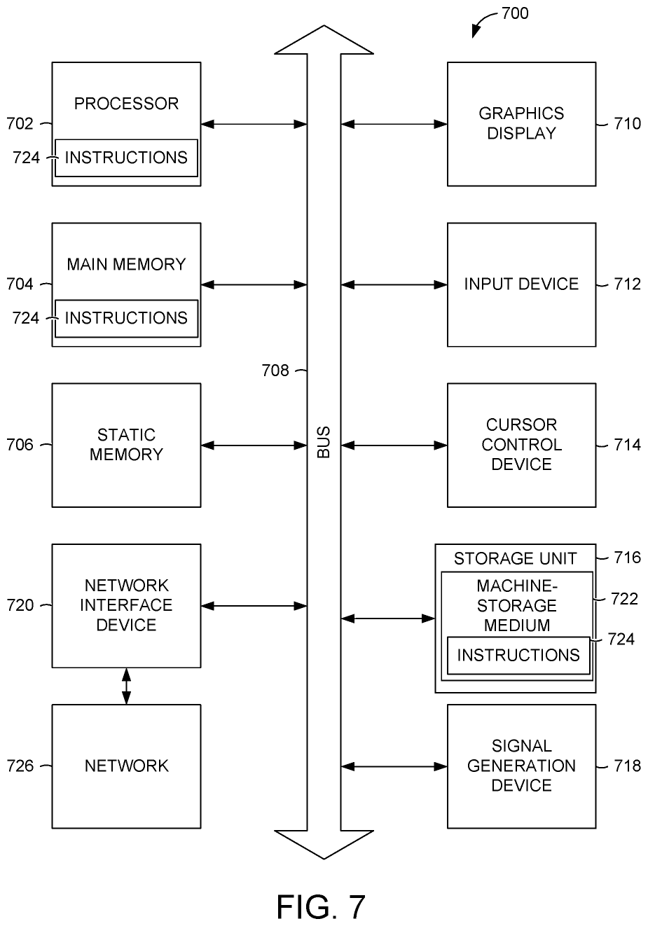

FIG. 1 is a diagram illustrating a network environment suitable for providing popular route inference and reconstruction, according to example embodiments. The network environment 100 includes a network system 102 communicatively coupled via a network 104 to a requester device 106a of a rider and a service provider device 106b of a driver (collectively referred to as “user devices 106”). In example embodiments, the network system 102 comprises components that monitor vehicles (e.g., via the requester device 106a and/or the service provider device 106b), store data obtained from the monitoring, and analyze the data. The data (referred to as “trip data”) can be analyzed to determine popular routes and segments (including detours) of the popular routes, in accordance with some embodiments. The components of the network system 102 are described in more detail in connection with FIG. 2 and may be implemented in a computer system, as described below with respect to FIG. 7.

The components of FIG. 1 are communicatively coupled via the network 104. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, a satellite network, a cable network, a broadcast network, another type of network, or a combination of two or more such networks. Any one or more portions of the network 104 may communicate information via a transmission or signal medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

In example embodiments, the user devices 106 are portable electronic devices such as smartphones, tablet devices, wearable computing devices (e.g., smartwatches), or similar devices. Alternatively, the service provider device 106b can correspond to an on-board computing system of a vehicle. The user devices 106 each comprises one or more processors, memory, touch screen displays, wireless networking system (e.g., IEEE 802.11), cellular telephony support (e.g., LTE/GSM/UMTS/CDMA/HSDP A), and/or location determination capabilities. The user devices 106 interact with the network system 102 through a client application 108 stored thereon. The client application 108 of the user devices 106 allow for exchange of information with the network system 102 via user interfaces, as well as in background. For example, the client application 108 running on the user devices 106 may determine and/or provide location information (e.g., current location in latitude and longitude), speed, and times (e.g., timestamps) associated with portions of the trip, via the network 104, for storage and analysis.

In example embodiments, a first user (e.g., a requester or rider) operates the requester device 106a that executes the client application 108 to communicate with the network system 102 to make a request for a transportation service such as transport or delivery service (referred to collectively as a “trip”). In some embodiments, the client application 108 determines or allows the first user to specify/select a pickup point or origin (e.g., of the user or an item to be delivered) and to specify a drop-off location or destination for the trip. The client application 108 also presents information, from the network system 102 via user interfaces, to the first user of the requester device 106a. For instance, the user interface can display a plurality of routes, including a reconstructed popular route, from the origin to the destination from which the user can select one route. The client application 108 also provides data to the network system 102 such as a current location (e.g., coordinates such as latitude and longitude), speed, heading, and/or times associated with events (e.g., U-turns) during navigation along the selected route.

A second user (e.g., a service provider or driver) operates the service provider device 106b to execute the client application 108 that communicates with the network system 102 to exchange information associated with providing a transportation or delivery service (e.g., to the user of the requester device 106a). The client application 108 presents information via user interfaces to the user of the service provider device 106b, such as invitations to provide the transportation or delivery service, navigation instructions (e.g., a route to the origin or the destination), and notifications, such as a notification that the rider may be late to the pickup point. Similar to the client application 108 on the requester device 106a, the client application 108 on the service provider device 106b can also provide data to the network system 102 such as a current location (e.g., coordinates such as latitude and longitude), speed, heading, and/or times associated with events during navigation by the service provider device 106b or vehicle.

In example embodiments, any of the systems, machines, or devices (collectively referred to as “components”) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 7, and such a special-purpose computer may be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 may be combined into a single system or device, and the functions described herein for any single component may be subdivided among multiple components (e.g., systems or devices). Additionally, any number of user devices 106 may be embodied within the network environment 100. Furthermore, some components or functions of the network environment 100 may be combined or located elsewhere in the network environment 100. For example, some of the functions of the networked system 102 may be embodied within other components of the network environment 100. Additionally, some of the functions of the user device 106 may be embodied within the network system 102. While only a single network system 102 is shown, alternative embodiments may contemplate having more than one network system 102 (e.g., for different regions) to perform server operations discussed herein for the network system 102.

FIG. 2 is a block diagram illustrating components of a network system 102 for inferring popular routes and reconstructing a popular route in real-time based on segments of the inferred popular routes, according to example embodiments. In various embodiments, the network system 102 monitors vehicles as they travel between an origin and destination to obtain and store trip data. In some examples, trip data comprises locations of user devices, speed, direction, timestamps, deviation locations from routes, convergence locations after detour, and other data. The network system 102 analyzes both current (e.g., real-time) and historical trip data, to reconstruct and recommend a popular route to a user. To enable these operations, the network system 102 comprises a data interface 202, a user interface (UI) component 204, a trip data storage 206, a service engine 208, an analysis engine 210, and a waypoint storage 212 all configured to communicate with each other (e.g., via a bus, shared memory, or a switch). In some cases, a machine learning engine 222 may be included to train one or more models used in the analysis.

The network system 102 can also comprise other components (not shown) that are not pertinent to example embodiments. Furthermore, any one or more of the components (e.g., engines, interfaces, storage) described herein may be implemented using hardware (e.g., a processor of a machine) or a combination of hardware and software. Moreover, any two or more of these components can be combined into a single component, and the functions described herein for a single component may be subdivided among multiple components.

The data interface 202 is configured to exchange data with the user devices 106 and cause presentation of one or more user interfaces generated by the UI component 204 on the user devices 106 (e.g., via the client application 108) including user interfaces to display routes for selection and navigation instructions. In some cases, the device interface 202 also receives/accesses trip data from the user devices 106 before, during, and after a trip. The trip data can include location information such as GPS traces (e.g., latitude and longitude with timestamp), speed, and times (e.g., timestamps) associated with events that occur during each trip (e.g., pickup time, arrival time). The trip data is stored to the trip data storage 206 by the data interface 202 for analysis.

The UI component 204 is configured to generate user interfaces. In some cases, the user interfaces display a plurality of recommended routes to a service requester (e.g., rider) include a popular route reconstructed by the network system 102 as will be discussed further herein. These recommended routes are transmitted via the data interface 202 and displayed by the client application 108 on the requester device 106a.

The data storage 206 is configured to store information associated with each user of the network system 102 including the trip data. The stored information includes trip data that includes, for example, primary or selected routes, deviation/convergence locations of detours from the primary or selected routes, timestamps associated with each trip, and events that occurred during each trip (e.g., pickups, drop-offs, detours). The stored information can also include user data including preferences. In some embodiments, the trip data is stored in or associated with a user profile corresponding to each user and includes a history of interactions using the network system 102.

The service engine 208 manages aspects of the transportation service including establishing a trip, reconstructing popular routes, recommending routes, and monitoring users before and during a trip. To enable these operations, the service engine 208 comprises a trip component 214 and a monitoring component 216. The service engine 208 may comprise other components (not shown) that are not pertinent to example embodiments.

The trip component 214 is configured to establish a trip based on a service request from the requester device 106a and recommend routes from an origin to a destination. In example embodiments, the origin is a starting point of the route while the destination is an ending point of a route. Thus, the origin can comprise a pickup point of the rider (or item to be delivered) and the destination is a drop-off point of the rider (or the item). In some cases, the trip component 214 may be referred to as a routing engine.

The routes recommended to a requester can be generated/selected based on being the fastest, shortest, lowest cost, most fuel-efficient, based on user preferences (e.g., avoid freeways, avoid hills, scenic route, frequently used route), based on routes frequently driven or selected by other users of the network system 102, or selected by the network system 102 based on other reasons or criteria. In example embodiments, one of the recommended routes is a popular route that is reconstructed by the trip component 214 from waypoints associated with popular segments that are derived by the analysis engine 210 as will be discussed in further detail below.

The monitoring component 216 captures trip data of a plurality of users traversing routes by monitoring the users and their user devices 106 throughout the transportation service. For example, the monitoring component 216 monitors navigation by the service provider of a routeline of a primary or selected route to the destination. In example embodiments, the monitoring component 216 receives location information (e.g., GPS coordinates) from one or more sensors associated with the user devices 106 in substantially real-time. Using the GPS information, the monitoring component 216 can identify where on the routeline the service provider device 106b is located and when and where the service provider device 106b may have detoured or deviated from the primary or selected route, if applicable. The tracked trip data is stored to the trip data storage 206 and used by the analysis engine 210 to determine popular routes, popular segments, and waypoints associated with the popular segments.

In particular, the trip data includes information about the point where most drivers diverged from a primary or selected route and another point where those drivers converged back to the route. This information is important in understanding micro-popularity patterns within a route between an origin and destination. Clusters of this information is used to derive preferred waypoints for origin/destination (O/D) hexagon pairs which have these divergence and convergence point pairs, as will be discussed in further detail below. In some cases, there can be more than one cluster for the same divergence point, which can result in multiple preferred waypoint candidates.

The analysis engine 210 is configured to determine (e.g., infer) popular routes and segments of those routes based on detours from a given route taken by users for each origin/destination pair. In some cases, the given route is the primary route. Specifically, the analysis engine 210 determines a set of routes that have a high probability of being traversed as a detour based on, for example, alternative routes that drivers took instead of a primary route. Using this set of popular routes, the analysis engine 210 derives waypoints from the different segments of the popular routes. In some cases, the popular routes and derived waypoints are for different time periods, such as rush hour, non-rush hour, quiet hours such as after midnight, and so forth. Accordingly, the analysis engine 210 includes a route selection component 218 and a waypoint component 220. In some embodiments, a machine learning model trained by the machine learning engine 222 is used by the analysis engine 210 to determine the popular routes and corresponding waypoints.

The route selection component 218 analyzes the trip data to identify the most frequently traveled routes between an origin/destination (O/D) pair. Initially, the route selection component 218 accesses trip data for all trips in a particular timeframe for the O/D pair from the trip data storage 206. The route selection component 218 then breaks the routes traversed for these trips into segments (or segment traversals) and detects detours where a driver deviated from the primary or selected route and converged back to the route. The segments can be road segments determined by a machine-learning model that, for example, breaks roads at intersections, junctions, splits, and so forth. In some cases, a count of the segment level traversals that are part of these detours is maintained by the route selection component 218. Additionally, a count of how may times each segment was suggested and traversed as well as segments that were suggested and not traversed is maintained. Probabilities or segment detour popularity scores are then computed for segments per O/D pair given the segment was traversed by not suggested for the trip.

Focusing solely on O/D specific trips limits the amount of information from sub-trajectories shared across trips from different O/Ds. At the same time, not taking the O/D context into account means the outcome can be heavily influenced by dominant O/Ds. For example, if trips starting in a different origin and going to a different destination are more frequent and have a detour on some segments shared in routes with the O/D under focus, those segments are considered as more important. Thus, the segment detour popularity score can be computed at both a city level and at an O/D level and combined by the route selection component 218. One method for combining is to use a weighted average, but other methods can be used.

The segment detour popularity scores are then aggregated back into a trip level concept using a weighted average by the route selection component 218. Specifically, considering the segment detour popularity scores, by applying a distance weighted average over the segments in a trip traversed trajectory, the scores are extended to the trip. As such, the aggregate score (e.g., a trip/route detour popularity score) can be interpreted as a combination of the distances of the trip's trajectory that are traversed with the computed probabilities. For instance, for a score of 0.5:
50% of the distance of the trip is 100% of time traversed as a detour;
75% of the distance of the trip is 67% of time traversed as a detour;
25% of the distance of the trip is 100% of the time traversed as a detour, another 50% of the distance of the trip is 50% of time traversed as a detour.
   Thus, a high trip/route detour popularity score indicates a trip where the majority of its distance may be taken on a detour. By scoring the trips in this scheme and ordering the scores by their respective O/Ds pairs, the route selection component 218 can identify top N routes that score above a threshold.

In some cases, frequency is also considered. For instance, a probability score based on 10/20 detours/route that satisfy the threshold is the same as a probability score based on 100/200 detours/route, but the latter is more frequent. Thus, the latter can be weighted higher by the route selection component 218.

While the route detour popularity score captures a good degree of popularity behavior, it ignores many other aspects. Thus, the route selection component 218 can further augment it by adding a summary of metrics from the detours that occurred on trips for the same O/D pair for each target trip. Detours belonging to trips in the same O/D pair are considered as targets, whereby each detour has a divergence point, a convergence point, a suggested route between these points, and a traversed route that may be different from the suggested route. Divergence/Convergence (D/C) hexagons can then be computed for each detour and hexagons computed for an entire trip (e.g., a hexline). Detours having corresponding D/C hexagons that do not match the hexline of the entire trip are removed. Among the remaining detours, a ratio of “a number of common road segments between the detour traversed section and a target trip” over “a count of all the segments in the detour traversed segment” is computed. The route selection component 218 can then remove detours with a computed ratio less than a predetermined threshold (e.g., 90%). Thus, a match occurs when an actual traversed section of the detour greatly aligns on a continuous stretch of an actual trajectory of the trip. In some cases, a first and last few percentages of the segments can be ignored, and a match is accepted (e.g., detours are viable for each trip they match) if there is at least a match threshold percentage (e.g., 90%) overlap of the remaining segments. The match threshold percentage is a tunable parameter.

The metrics are computed over concepts such as traversal counts or frequency and distances. The metrics surface at various levels including road segment, O/D spatial group (e.g., h3 hex or S2cell), D/C spatial group (e.g., h3 hex or S2cell), O/D-D/C spatial group (e.g., origin (O), destination (D) as well as divergence (D), convergence (C) all can be hex or s2cell or any similar spatial grouping mechanism where the detour occurs in a D/C that was for a trip going from origin to destination), O/D-D/C_trip spatial group (e.g., similar to above but the trajectory taken as a detour between divergence (D) and convergence (C) must be part of the trip trajectory, note that the detour here does not necessarily belong to the trip trajectory in the group). Additionally, time dimension is considered so all of these metrics can be further broken down by a classification of time such as rush hour, non-rush hour, and quiet hour.

The route selection component 218 then computes aggregated metrics which give a more quantitative view of the selected trip's detour behavior. In turn, these metrics can be used to confirm the trip selection using the route level detour popularity score and to filter out non-confirming (likely false positive) trips. Further still, the route selection component 218 can remove detours that have a count of one (1) since these detours are not informative and likely comprising from a same target trip. The remaining detours are considered matching detours to each target trip. Each trip can have matching detours at multiple places along the way. The matching detours are aggregated at an O/D route level (corresponding to the target trip) into metrics. These metrics include a count of all matching detours, a count of unique D/C hexes from matching detours, a count of unique trips that have at least one matching detour (e.g., a trip can have multiple detours that have happened at the time of the trip based on the trip data), an average distance traversed over all the detours, an average suggested distance over all the detours, and optionally any other metric that makes sense at this level. These metrics can be joined at the O/D route level with the route detour popularity score and counts.

The route selection component 218 then reorders the routes, based on the route detour popularity score and the aggregated detour metrics, and selects a top M route(s) out of the N trips per O/D. In one case, M is 1, but other values can be used. In one embodiment, a resulting table for ranking of the routes (O/D route) is used by taking computed aggregates at an O/D route level and the scores as features into a ranking model. The ranking model may normalize the features into discrete values in a same range (e.g., 0 to 50, 0 to 100). A quantile discretizer can be used, which assigns values based on cumulative frequency of values in some sense, instead of an absolute value. The trip with the highest score in each O/D pair is selected as the popular route.

In some embodiments, the Earth's surface is discretized into fine grained hexagons (or hexes) which are used to represent a trip as a sequence of such hexagons. Trips can then be grouped by their origins and destinations into the corresponding hexagons. When the hexagons for origins and destinations are the same, these trips are placed in the same bin. All of the above computations and analysis can then be performed per these bins and sometimes for all trips in a city. For example, a count of a number of times a hexagon was traversed but not suggested, normalized over all the times it was traversed can indicate a hexagon's detour popularity score. This process over all the trips in the city, results in a hex-map of detour popularity scores. Similarly, by only considering the trips within the same O/D group, a single hex-map per O/D of the relevant hexagons detour popularity is generated.

In a further extension, the above computations and analysis can be performed based on time. For instance, the trips can be grouped by time of day such as morning rush hour (e.g., 7 am-9 am), evening rush hour (e.g., 5 pm-7 pm), and quiet hours (e.g., 12 midnight to 5 am) within the O/D hexagon bins. For instance, segment detour popularity scores for all segments are computed within each time bin as a total number of trips that pass through a segment/total number of trips in that time bin. For all trips, a route detour popularity score is computed by aggregating the segment detour popularity scores for each O/D time (O/D(T)) bin using the above discussed distance weighted average. The routes are then ranked based on route detour popularity scores and top N routes per O/D(T) with the highest scores selected.

In some of these embodiments, the route selection component 218 uses a machine learning model to determine the most popular segments and/or routes. The machine learning model can be trained with training data including primary routes, detected detours (including segments), clusters of detours, and corresponding popularity scores (e.g., segment detour popularity scores, route detour popularity score). Subsequently, new trip data is applied by the route selection component 218 to the machine learning model to determine/revise detour clusters, the most popular segments, and/or the most popular routes.

The waypoint component 220 is configured to determine waypoints of segments that, in response to a real-time request, can be combined to reconstruct a trajectory of a popular route for selection. Since the matching detours already correspond to a portion of the trip's trajectory, by grouping them by their divergence and convergence points (with a spatial resolution) per O/D pair, the waypoint component 220 can determine sub-trajectories of interest. That is, a matching O/D divergence/convergence (D/C) group will have almost the same traversed sub-trajectory. In one case, the detours are grouped by matching D/C hexagons. The waypoint component 220 can then determine aggregate metrics (e.g., scores) for each D/C group. Based on the aggregated metrics, a predetermined number of highest scoring D/C groups (e.g., most important D/C groups) are selected by the waypoint component 220. For each O/D-D/C route (or group), the waypoint component 220 selects a best matching detour that comprises a highest matching ratio, as discussed above. Traversed road segments are then extracted from the best matching detour. In some cases, a length of each segment is computed using its geometry.

From each of the selected D/C groups, candidate waypoints are identified. For example, the waypoint component 220 selects segments (e.g., waypoints) at specific distances between the divergence point and convergence point on the traversed path. In some cases, the waypoint component 220 selects three candidate waypoints: one at the middle of the detour (0.5 relative distance), one in the beginning of the detour (e.g., 0.25 relative distance), and one towards the end of the detour (0.75 relative distance). Each candidate waypoint is associated with the metrics for their D/C group. In some cases, a higher score may be assigned to the middle point, such that given two D/C groups, if they are both highly important, their middle points are selected first as the top picks before adding more candidate waypoints to the mix.

In some embodiments, the waypoint component 220 removes segments that are too close to the origin and/or destination. This may be based on different definitions of proximity such as, for example, haversine distance meters, distance meters over a trajectory until a beginning of a road segment, and/or distance meters over a trajectory from a first road segment that lies outside of a S2Cell (from a library of spherical geometry) corresponding to the origin or destination S2Cell. Remaining segments are referred to herein as route core segments. Candidate waypoints that are not in the route core segments can be removed by the waypoint component 220. This is done to avoid picking waypoints at undesirable locations such as locations too close to the origin or destination.

Considering variations in divergence and convergence locations may result in neighboring spatial cells (e.g., H3 hexagons or S2Cells) whereby two D/C groups can overlap, the waypoint component 220 may “deduplicate” waypoints such that only one waypoint in close proximity to another is selected. The assumption is that routing through two or more nearby waypoints on the same traversed sub-trajectory does not provide more information to reconstruct the path. To achieve this, the waypoint component 220 can group the waypoints in H3 hexagons of fine resolution and from each group, select the one waypoint with the highest metrics (e.g., the D/C aggregate metrics and the corresponding segment detour popularity score). Alternatively, the waypoint component 220 can cluster segments and only keep one candidate waypoint from each cluster of candidates. Additionally, candidate waypoints that may force a u-turn or a loop behavior can be removed (e.g., using a path discretization technique) by the waypoint component 220.

The remaining candidate waypoints are considered prime waypoint candidates. In some examples, there are more candidate waypoints than can effectively be used in real-time serving of routing information. In these cases, the waypoint component 220 further reduces the number of candidate waypoints. For example, the waypoint component 220 can reduce the number of waypoints to a predetermine number, such as to nine waypoints per trip. In one embodiment, the waypoint component 220 groups detours at an O/D-D/C level without regards to a target trip. For example, the waypoint component 220 groups detours belonging to possibly different trips that share the same origin and destination S2Cells and have the same divergence and convergence hexes. Metrics for each O/D-D/C group are then aggregated, such as by the number of detours, number of unique trips with at least one detour in this group, average traversed and suggested distance, and so forth. For all prime waypoint candidate segments, these metrics are joined at their corresponding O/D-D/C as well as segment detour popularity scores and count from earlier stages with segment lengths and features to differentiate between waypoints that belong to the same O/D-D/C such as their relative position within the D/C group. For example, a bigger value is used for the waypoint corresponding to 0.5 so that waypoints from the middle point of the detours are prioritized over those in the proximity of the divergence point and convergence point.

The waypoint component 220 ranks and orders the candidate waypoints by their metrics and segment detour popularity scores and selects a top K number of waypoints for each top number of D/C groups. Specifically, the waypoint component 220 orders the waypoints on traversal of the trip such that an order that each waypoint is visited conforms to the order that the target trip has passed through. For each waypoint segment, a median of points representing the geometry of the segment is used as the waypoint coordinate. These waypoints are then stored to the waypoint storage 212 for use in real-time. The list of waypoints may have a latitude, longitude, heading/azimuth, and/or a unique identifier.

In some of these embodiments, the waypoint component 220 uses a machine learning model to determine the waypoints and/or highest-ranking waypoints for each segment. The machine learning model can be trained with training data including D/C groups for various detours, extracted waypoints, and corresponding scores. Subsequently, new trip data is applied by the waypoint component 220 to the machine learning model to determine/revise waypoints for different trajectories or popular routes.

The concept of hex detour popularity scores can be extended to route detour level popularity scores as an aggregate over all the hexes in a route. Thus, actual trips can be grouped by their O/D hexagons and the trips ranked based on the route detour popularity score. A top N number of routes can then be selected. Next, the hexes along the resulting route that have the highest detour popularity score (top K) are selected and their coordinates (e.g., center) used as waypoints.

In various embodiments, the analysis of the trip data can be performed at any time, during regular intervals (e.g., every 4 hours, every 6 hours, nightly, once a week), based on an event (e.g., when a certain amount of trip data is received), and/or be triggered manually. Thus, the network system 102 is continually updated with the most current popular routes and detour segments which results in a more accurate and current popular route (e.g., based on a latest traffic and road conditions) being reconstructed. This improves the accuracy of the network system 102 in reconstructing the popular routes.

The machine learning engine 222 trains one or more machine learning models that are used by the analysis engine 210 to identify one or more of popular routes, popular segments within the popular routes, and top-ranking waypoints of the popular segments/routes. In various embodiments, the machine learning engine 222 uses data from past trips to train the machine learning models. As such, the machine learning engine 222 includes a feature extractor 224 and a training component 226.

The feature extractor 224 extracts features that are used to train the machine learning model. In example embodiments, the feature extractor 224 accesses historical trip data from the trip data storage 206. The feature extractor 224 extracts features from historical trip data, such as a primary route, locations of detours, divergence points, convergence points, and other data.

The extracted features are provided to the training component 226, which uses the extracted features to train one or more machine learning models. In some embodiments, a machine learning model is trained to identify the most popular routes that include a detour. In some embodiments, a machine learning model is trained to identify the most popular segments within the most popular routes that include a detour. Further still, a machine learning model can be trained to identify highest ranking waypoints based on the most popular routes and segments. Additionally, a machine learning model can be trained to reconstruct a popular route based on a given origin and destination.

As additional feedback and trip data is received, the detours and popularity can change over time. Thus, the additional feedback and trip data can be used to retrain the one or more machine learning models. As a result, the machine learning models can become more accurate/refined or change with changing conditions (e.g., roadway is widened with more lanes, construction closes one or more lanes)—thus improving the accuracy of the network system 102. The training and retraining of the one or more machine learning models can occur at any time, during regular intervals (e.g., nightly, once a week), based on an event (e.g., when a certain amount of trip data is received), and/or be triggered manually.

The trip component 214 receives a transportation request and reconstructs, in real-time, a popular route based on the origin and destination indicated in the transportation request. Given one or more of a route between the origin and destination, the trip component 214 identifies a candidate set of segments along the route. The trip component 214 then accesses the corresponding waypoints for the candidate set of segments from the waypoint storage 212 and re-ranks these waypoints based on their popularity score and popularity of the D/C clusters associated with the segments. The reranking can also be based on the time of day of the request or current conditions. For example, an accident in one segment may cause corresponding waypoints to be ranked lower. The trip component 214 selects the top-ranking waypoints to reconstruct a popular route. In some cases, a route application interface protocol (API) is called with the top-ranking waypoints and a resulting route evaluated against an original (non-detoured) route.

For example, a route between an origin and destination may be made up of five popular segments. When the rider requests the route, the trip component 214 pieces a popular route together by using those five popular segments whereby the segments can include popular detours (e.g., based on time of day or traffic conditions). Thus, for example, if there is an accident along a freeway (e.g., a middle segment of the route) at the time of the request, that segment is not a good option and can be replaced with a different segment.

In some cases, a machine learning model can be used by the trip component 214 to determine the popular routes. Given the origin and destination and, in some cases, the time of day, the trip component 214 applies the data to the machine learning model, which can identify the candidate set of segments along the route, corresponding waypoints for the candidate set of segments, and top-ranking waypoints. The top-ranking waypoints are then used to reconstruct a popular route by the machine learning model.

The trip component 214 can suggest this popular route along with a primary route that is typically recommended based on distance, time, or price. In some case, other routes can be included such as a most fuel-efficient route, an avoid-freeway route, or a scenic route.

While the trip data storage 206 and the waypoint storage 212 are shown to be embodied within the network system 102, alternative embodiments can locate the data storage 206 or the waypoint storage 212 elsewhere and communicatively couple the data storage 206 or waypoint storage 212 to the network system 102. Furthermore, while the data storage 206 and waypoint storage 212 are shown in FIG. 2 to be separate data storages, the two storages 206 and 212 can be combined into a single data storage.

Some embodiments include a validation process. In these embodiments, the analysis engine 210 includes a validation component 228. For each O/D to waypoint list, the validation component 228 creates two routing engine requests: a primary route (e.g., without waypoints, only the origin and destination) and a popular route (e.g., using waypoints). The validation component 228 also considers a route selected by the route selection component 218 for this O/D which is referred to as a data-inferred popular route. Given polylines of the response from the routing engine (e.g., trip component 214), the validation component 228 performs a trajectory similarity comparison analysis between the three (e.g., primary route from routing engine, popular route from routing engine, and data-inferred popular route). The validation component 228 then filters records where (1) routing fails, (2) popular route and data-inferred popular route are not similar, or (3) primary route and popular route are very similar. In example implementations, the records comprise the output of the offline route and waypoint inference algorithm (e.g., for a O/D, a list of waypoints and selected popular trajectory), routing request context that is sent to the routing engine that asked for a route that passes through these waypoints, and a routing response context that returns a primary response (e.g., path from origin to destination ignoring the waypoints) and the waypoint routing response (e.g., path from origin to destination passes through the waypoints). Each record has enough information to perform a validation on the selected route and waypoints. The valid records for use in real-time serving are then stored.

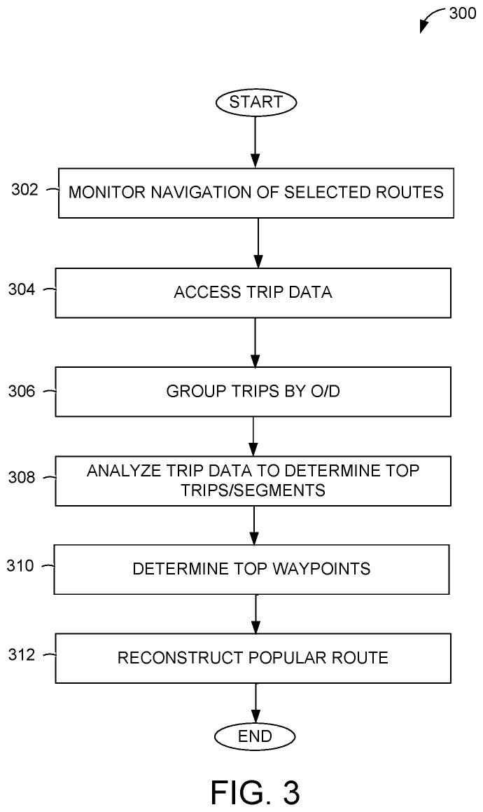

FIG. 3 is a flowchart illustrating operations of a method 300 for inferring and reconstructing popular routes, according to example embodiments. Operations in the method 300 can be performed by components of the network system 102 described above with respect to FIG. 2. Accordingly, the method 300 is described by way of example with reference to the network system 102. However, it shall be appreciated that at least some of the operations of the method 300 may be deployed on various other hardware configurations or be performed by similar components residing elsewhere in the network environment 100. Therefore, the method 300 is not intended to be limited to the network system 102.

In operation 302, the network system 102 monitors navigation of routes. For instance, the monitoring component 216 monitors navigation by the service provider, via the service provider device 106b of a routeline of a route to the destination. Additionally or alternatively, the monitoring component 216 monitors traversal of the route via the requester device 106a. In some examples, the monitoring component 216 receives location information (e.g., GPS coordinates) from one or more sensors associated with the user devices 106 in substantially real-time during a transportation service. Using the GPS information, the monitoring component 216 identifies where on the routeline the user device 106 is located and when and where the user device 106 detoured or deviated from a primary route, if applicable. The tracked trip data is stored to the trip data storage 206 and used at a later time by the analysis engine 210 to determine popular detours and corresponding waypoints.

The analysis of the trip data to identify popular and corresponding waypoints can be performed at any time, during regular intervals (e.g., every 4 hours, every 6 hours, nightly, once a week), based on an event (e.g., when a certain amount of trip data is received), and/or be triggered manually. In operation 304, the network system 102 accesses the trip data for a predetermined period of time. In some cases, the predetermined period of time is a period since a last analysis was conducted. In some cases, the predetermined period is for a set time period (e.g., last 6 hours, last 2 days, last week) on a continuing rolling basis.

In operation 306, the route selection component 218 of the analysis engine 210 groups trips by origin and destination. In some cases, the Earth's surface is discretized into hexagons and a trip is represented as a sequence of such hexagons. Trips can then be grouped by their origin and destination hexagons. That is, if the hexagons for origins and destinations are the same, these trips are placed in the same group or bin. The trips can also be grouped by time within these bins. For instance, the trips can be grouped by time of day such as morning rush hour (e.g., 7 am-9 am), evening rush hour (e.g., 5 pm-7 pm), and quiet hours (e.g., 12 midnight to 5 am) within the grouped origin/destination bins.

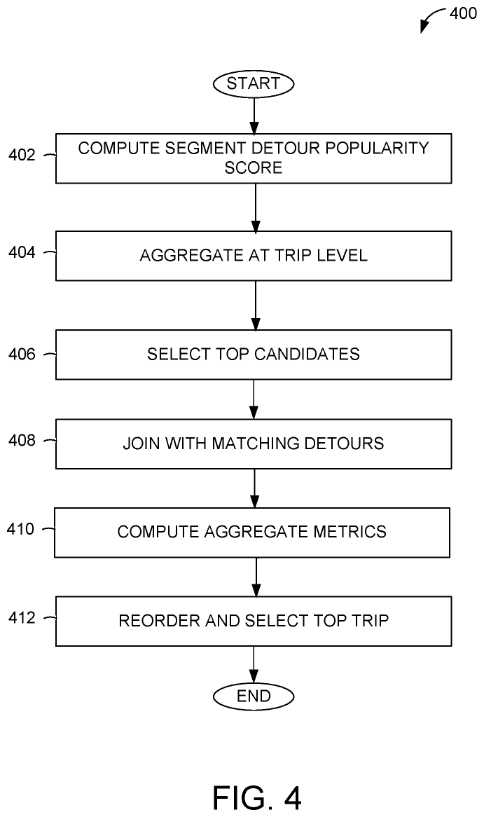

In operation 308, the route selection component 218 analyzes the trip data to determine top or candidate popular trips and popular segments (e.g., popular detours). Operation 308 will be discussed in more detail in connection with FIG. 4 below.

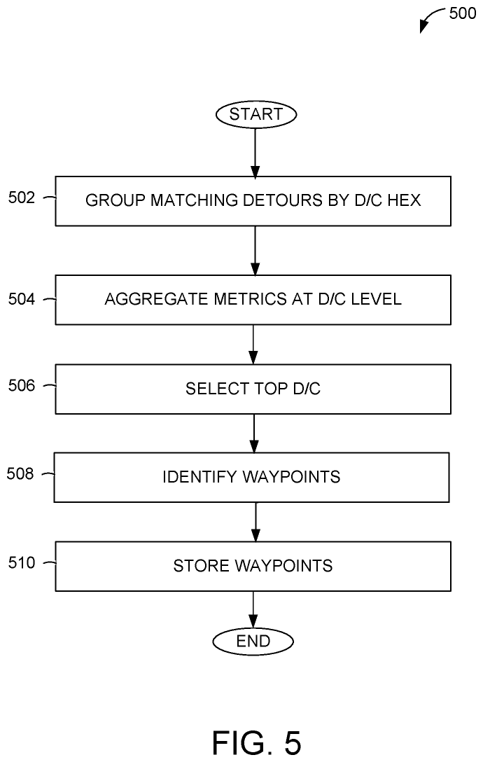

In operation 310, the waypoint component 220 of the analysis engine 210 determines top-ranking waypoints for top or candidate routes and segments. Operation 310 will be discussed in more detail in connection with FIG. 5 below.

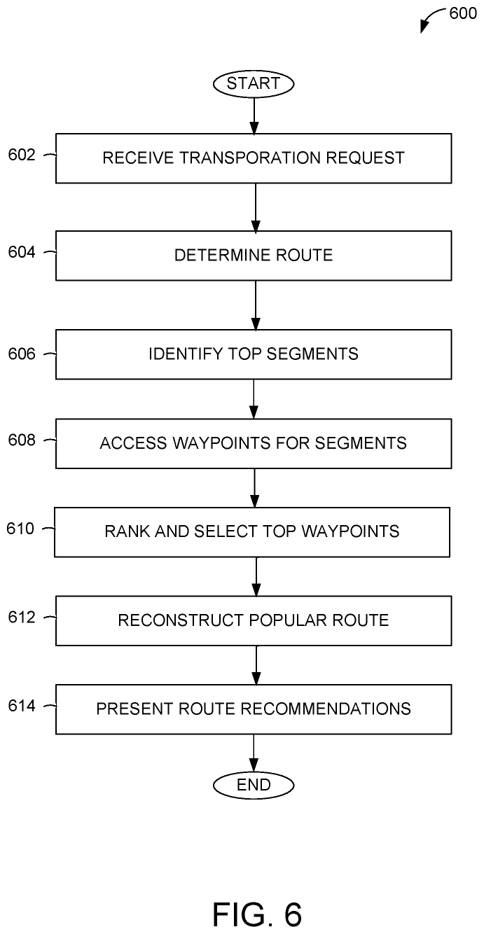

In operation 312, the network system 102 reconstructs a popular route based on the waypoints determined in operation 310. Operation 312 will be discussed in more detail in connection with FIG. 6 below.

FIG. 4 is a flowchart illustrating operations of a method 400 (e.g., operation 308) for analyzing trip data to determine top or most popular trips and detour segments, according to example embodiments. Operations in the method 400 may be performed by the network system 102, using components of the analysis engine 210 (e.g., route selection component 218) described above with respect to FIG. 2. Accordingly, the method 400 is described by way of example with reference to the analysis engine 210. However, it shall be appreciated that at least some of the operations of the method 400 may be deployed on various other hardware configurations or be performed by similar components residing elsewhere in the network environment 100. Therefore, the method 400 is not intended to be limited to the analysis engine 210.

In operation 402, the route selection component 218 computes segment detour popularity scores. Using trip data for all trips in a particular timeframe for an O/D pair being analyzed, the route selection component 218 breaks the routes traversed for these trips into segments (or segment traversals) and detects detours where a driver deviated from a primary route and converged back to the primary route. In some cases, the route selection component 218 maintains a count of the segment level traversals that are part of these detours. Additionally, counts of how many times each segment was suggested and traversed as well as segments that were suggested and not traversed are maintained. Probabilities or segment detour popularity scores are then computed for segments per O/D given the segment was traversed but not suggested for the trip.

In operation 404, the route selection component 218 aggregates the segment detour popularity scores back into a trip level concept using a weighted average. Specifically, considering the segment detour popularity score, by applying a distance weighted average over the segments in a trip traversed trajectory, the scores are extended to the trip. As such, the aggregated score (e.g., a trip/route detour popularity score) can be interpreted as a combination of the distances of the trip's trajectory that are traversed with the computed probabilities.

In operation 406, the route selection component 218 selects top or highest scoring candidates from the aggregated scores from operation 404. A high trip/route detour popularity score indicates a trip where the majority of its distance is taken on a detour. By scoring the trips in this scheme and ordering the scores in their respective O/D pairs, the route selection component 218 can identify top N routes that score above a threshold.

In operation 408, the route selection component 218 joins these top routes with matching detours. While the route detour popularity score captures a good degree of popularity behavior, the route selection component 218 can further augment it by adding a summary of metrics from all the detours that occurred on trips for the same O/D pair. In particular, the route selection component 218 joins matching detours to compute aggregated metrics. A match occurs when an actual traversed section of the detour greatly aligns on a continuous stretch of an actual trajectory of the trip with a match threshold percentage (e.g., 85%) overlap.

In operation 410, the route selection component 218 computes the aggregated metrics.

In operation 412, the route selection component 218 reorders the routes based on the aggregated metrics and on the route detour popularity scores. The route selection component 218 then selects one or more top or highest scoring trips out of the N trips (e.g., the candidates) selected in operation 406. In particular, scores are assigned based on multiple features to each route and the top N are selected.

FIG. 5 is a flowchart illustrating operations of a method 500 (e.g., operation 310) for determining top or highest ranking waypoints, according to some example embodiments. Operations in the method 500 may be performed by the network system 102, using components of the analysis engine 210 (e.g., the waypoint component 220) described above with respect to FIG. 2. Accordingly, the method 500 is described by way of example with reference to the analysis engine 210. However, it shall be appreciated that at least some of the operations of the method 500 may be deployed on various other hardware configurations or be performed by similar components residing elsewhere in the network environment 100. Therefore, the method 500 is not intended to be limited to the analysis engine 210.

In operation 502, the waypoint component 220 groups matching detours by divergence/convergence (D/C) hexagons for a particular route. Specifically, the waypoint component 220 groups different segments that represent the detours by D/C hexagons. In these cases, the routes can be converted to hexagons (or hexes) at a same level as the D/C hexagons.

In operation 504, the waypoint component 220 aggregates metrics at a D/C level for each group. The purpose of grouping detours by D/C is to assign values to each group. For example, the assigned values can include aggregate metrics, such as count of the detours or average distance suggested/traversed. These metrics are then aggregated again into one ranking score from which the top or highest ranking waypoints are selected.

In operation 506, the waypoint component 220 selects a predefined number of highest scoring D/C segments based on the aggregated metrics.

In operation 508, the waypoint component 220 identifies waypoints for the top or highest scoring D/C segments. In some cases, the waypoint component 220 identifies three waypoints: one at the middle of the detour, one in the beginning of the detour, and one towards the end of the detour. Each waypoint is associated with the metrics for their D/C group. In some cases, a higher score may be assigned to the middle point, such that given two D/C groups, if they are both highly important, their middle points are selected first as the top picks. In some cases, the waypoint component 220 deduplicates waypoints such that only one waypoint in close proximity to another is selected. To achieve this, the waypoint component 220 groups the waypoints in H3 hexagons of fine resolution and from each group, selects the one waypoint with the highest metrics (e.g., the D/C aggregate metrics and the corresponding segment detour popularity score). The waypoint component 220 can order the candidate waypoints by their metrics and segment detour popularity scores and select top K waypoints.

The waypoint component 220 then stores these top-ranking or highest scoring waypoints in operation 510 for use in real-time route recommendation. Specifically, the waypoint component 220 stores these waypoints in the waypoint data storage 212.

FIG. 6 is a flowchart illustrating operations of a method 600 for presenting route recommendations including a reconstructed popular route, according to example embodiments. Operations in the method 600 may be performed by the network system 102, using components of the service engine 208 (e.g., trip component 214) described above with respect to FIG. 2. Accordingly, the method 600 is described by way of example with reference to the service engine 208. However, it shall be appreciated that at least some of the operations of the method 600 may be deployed on various other hardware configurations or be performed by similar components residing elsewhere in the network environment 100. Therefore, the method 600 is not intended to be limited to the service engine 208.

In operation 602, the network system 102 receives a request from a user device (e.g., requester or rider device) for transportation service. In example embodiments, the data interface 202 receives the request and transmits the request to the service engine 208. The request includes an indication of an origin and a destination.

In operation 604, the trip component 214 determines a primary route between the origin and destination. In some cases, the primary route is a route assuming no traffic or delays. In some cases, a primary route is a fastest route, a shortest route, and/or a cheapest route.

In operation 606, the trip component 214 identifies a candidate set of segments for detours that occur on the primary route. Given the primary route between the origin and destination, route detour popularity scores along the primary route, and a set of divergence/convergence pairs overlaid on a trajectory of the primary route, the trip component 214 selects a candidate set of segments.

In operation 608, the trip component 214 accesses waypoints for the candidate set of segments from the waypoint data storage 212. The trip component 214 then ranks the waypoints based on their popularity score and popularity of the D/C clusters associated with the segments in operation 610 and selects top-ranking waypoints based on the ranking. The ranking can also be based on the time of day of the request.

In operation 612, the trip component 214 reconstructs a popular route using the selected waypoints. In some cases, a route application programming interface (API) is called with the top-ranking waypoints and a resulting route evaluated against the original (non-detoured), primary route. In particular, a routing engine (e.g., trip component 214) computes a route for the given origin and destination, assuming the O/D fall within an O/D S2Cell with identified waypoints, using the waypoints to generate a reconstructed popular route. In some cases, the reconstructed popular route is validated by the validation component 228. In some examples, the validation comprises comparing a duration and distance of the reconstructed popular route to those of the primary route which is the route computed without waypoints.

In operation 614, suggested routes are presented to a service requester via their service requester device 106a. The suggested routes can include the primary route, the reconstructed popular route, and/or other routes such as a most fuel-efficient route or other routes determined based on user preferences of the service requester (e.g., a route that avoids freeways or a scenic route).

FIG. 7 illustrates components of a machine 700, according to some example embodiments, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 7 shows a diagrammatic representation of the machine 700 in the example form of a computer device (e.g., a computer) and within which instructions 724 (e.g., software, a program, an application, an applet, an app, or other executable code) for causing the machine 700 to perform any one or more of the methodologies discussed herein may be executed, in whole or in part.

For example, the instructions 724 may cause the machine 700 to execute the flow diagrams of FIG. 3 through FIG. 6. In one embodiment, the instructions 724 can transform the machine 700 into a particular machine (e.g., specially configured machine) programmed to carry out the described and illustrated functions in the manner described.

In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724 (sequentially or otherwise) that specify actions to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more components described herein.

The machine 700 may further include a graphics display 710 (e.g., a plasma display panel (PDP), a light emitting diode (LED) display, a liquid crystal display (LCD), a projector, or a cathode ray tube (CRT), or any other display capable of displaying graphics or video). The machine 700 may also include an input device 712 (e.g., a keyboard), a cursor control device 714 (e.g., a mouse, a touchpad, a trackball, a joystick, a motion sensor, or other pointing instrument), a storage unit 716, a signal generation device 718 (e.g., a sound card, an amplifier, a speaker, a headphone jack, or any suitable combination thereof), and a network interface device 720.

The storage unit 716 includes a machine-storage medium 722 (e.g., a tangible machine-storage medium) on which is stored the instructions 724 (e.g., software) embodying any one or more of the methodologies or functions described herein. The instructions 724 may also reside, completely or at least partially, within the main memory 704, within the processor 702 (e.g., within the processor's cache memory), or both, before or during execution thereof by the machine 700. Accordingly, the main memory 704 and the processor 702 may be considered as machine-storage media (e.g., tangible and non-transitory machine-storage media). The instructions 724 may be transmitted or received over a network 726 via the network interface device 720.

In some example embodiments, the machine 700 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the components described herein.

### Executable Instructions and Machine-Storage Medium

The various memories (e.g., 704, 706, and/or memory of the processor(s) 702) and/or storage unit 716 may store one or more sets of instructions and data structures (e.g., software) 724 embodying or utilized by any one or more of the methodologies or functions described herein. These instructions, when executed by processor(s) 702 cause various operations to implement the disclosed embodiments.

As used herein, the terms “machine-storage medium,” “device-storage medium,” “computer-storage medium” (referred to collectively as “machine-storage medium 722”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 722 include non-volatile memory, including by way of example semiconductor memory devices, for example, erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 722 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage medium/media and signal medium/media. Thus, the terms include both storage devices/media and carrier waves/modulated data signals.

The instructions 724 may further be transmitted or received over a communications network 726 using a transmission medium via the network interface device 720 and utilizing any one of a number of well-known transfer protocols (e.g., HTTP). Examples of communication networks 726 include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 724 for execution by the machine 700, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some embodiments, a hardware component may be implemented mechanically, electronically, or any suitable combination thereof. For example, a hardware component may include dedicated circuitry or logic that is permanently configured to perform certain operations. For example, a hardware component may be a special-purpose processor, such as a field programmable gate array (FPGA) or an ASIC. A hardware component may also include programmable logic or circuitry that is temporarily configured by software to perform certain operations. For example, a hardware component may include software encompassed within a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where the hardware component comprises a general-purpose processor configured by software to become a special-purpose processor, the general-purpose processor may be configured as respectively different special-purpose processors (e.g., comprising different hardware components) at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, a processor being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented components may be located in a single geographic location (e.g., within a home environment, an office environment, or a server farm). In other example embodiments, the one or more processors or processor-implemented components may be distributed across a number of geographic locations.

### EXAMPLES

Example 1 is a method for providing popular route inference and reconstruction. The method comprises capturing trip data of a plurality of users traversing routes by monitoring user devices of the plurality of users; analyzing the trip data between an origin/destination (O/D) pair to determine candidate popular trips between the O/D pair comprising detours; determining top-ranking waypoints of segments of the candidate popular trips; storing the top-ranking waypoints of the O/D pair in a waypoint data storage; in response to receiving a request for a transportation service between the O/D pair from a user, reconstructing, by a trip component, a popular route using the top-ranking waypoints; and causing presentation on a user device of the user of a plurality of route options for selection by the user, the plurality of route options including the reconstructed popular route.

In example 2, the subject matter of example 1 can optionally include wherein analyzing the trip data comprises generating segment detour popularity scores for segments of the O/D pair whereby the segments were traversed by not suggested for a trip.

In example 3, the subject matter of any of examples 1-2 can optionally include wherein analyzing the trip data comprises generating a trip detour popularity score based on the segment detour popularity scores by applying a distance weighted average over the segments.

In example 4, the subject matter of any of examples 1-3 can optionally include wherein analyzing the trip data comprises joining matching detours to compute aggregated metrics, a segment being a matching detour when a threshold percentage of the segment matches a continuous stretch of a trajectory of a trip.

In example 5, the subject matter of any of examples 1-4 can optionally include wherein determining the top-ranking waypoints comprises grouping different segments that represent the detours by divergence/convergence (D/C) hexagons, wherein the routes are converted to hexagons at a same level as the D/C hexagons; aggregating metrics at a D/C level for each grouping of a detour; and selecting a predetermined number of D/C segments for each detour based on the aggregated metrics.

In example 6, the subject matter of any of examples 1-5 can optionally include wherein determining the top-ranking waypoints comprises extracting three waypoints for each selected D/C segment, the three waypoints comprising a waypoint at a middle of the detour, a waypoint in a beginning of the detour, and a waypoint towards an end of the detour; and associating the aggregated metrics for their respective D/C segment to each waypoint, the top-ranking waypoints being based on the associated metrics.

In example 7, the subject matter of any of examples 1-6 can optionally include wherein reconstructing the popular route comprises determining a primary route based on the request; identifying a candidate set of segments for detours that occur on the primary route; accessing waypoints associated with the candidate set of segments from the waypoint data storage; and ranking the accessed waypoints based on corresponding popularity scores to identify the top-ranking waypoints.

In example 8, the subject matter of any of examples 1-7 can optionally include training one or more machine learning models based on training data derived from the trip data, the one or more machine learning models used to analyze the trip data and determine one or more of the candidate popular trips, popular segments within the candidate popular trips, or the top-ranking waypoints; receiving new trip data; and retraining the one or more machine learning models using the new trip data.

Example 9 is a system for providing popular route inference and reconstruction. The system includes one or more processors and a memory storing instructions that, when executed by the one or more hardware processors, causes the one or more hardware processors to perform operations comprising capturing trip data of a plurality of users traversing routes by monitoring user devices of the plurality of users; analyzing the trip data between an origin/destination (O/D) pair to determine candidate popular trips between the O/D pair comprising detours; determining top-ranking waypoints of segments of the candidate popular trips; storing the top-ranking waypoints of the O/D pair in a waypoint data storage; in response to receiving a request for a transportation service between the O/D pair from a user, reconstructing a popular route using the top-ranking waypoints; and causing presentation on a user device of the user of a plurality of route options for selection by the user, the plurality of route options including the reconstructed popular route.

In example 10, the subject matter of example 9 can optionally include wherein analyzing the trip data comprises generating segment detour popularity scores for segments of the O/D pair whereby the segments were traversed by not suggested for a trip.

In example 11, the subject matter of any of examples 9-10 can optionally include wherein analyzing the trip data comprises generating a trip detour popularity score based on the segment detour popularity scores by applying a distance weighted average over the segments.

In example 12, the subject matter of any of examples 9-11 can optionally include wherein analyzing the trip data comprises joining matching detours to compute aggregated metrics, a segment being a matching detour when a threshold percentage of the segment matches a continuous stretch of a trajectory of a trip.

In example 13, the subject matter of any of examples 9-12 can optionally include wherein determining the top-ranking waypoints comprises grouping different segments that represent the detours by divergence/convergence (D/C) hexagons, wherein the routes are converted to hexagons at a same level as the D/C hexagons; aggregating metrics at a D/C level for each grouping of a detour; and selecting a predetermined number of D/C segments for each detour based on the aggregated metrics.

In example 14, the subject matter of any of examples 9-13 can optionally include wherein determining the top-ranking waypoints comprises extracting three waypoints for each selected D/C segment, the three waypoints comprising a waypoint at a middle of the detour, a waypoint in a beginning of the detour, and a waypoint towards an end of the detour; and associating the aggregated metrics for their respective D/C segment to each waypoint, the top-ranking waypoints being based on the associated metrics.

In example 15, the subject matter of any of examples 9-14 can optionally include wherein reconstructing the popular route comprises determining a primary route based on the request; identifying a candidate set of segments for detours that occur on the primary route; accessing waypoints associated with the candidate set of segments from the waypoint data storage; and ranking the accessed waypoints based on corresponding popularity scores to identify the top-ranking waypoints.

In example 16, the subject matter of any of examples 9-15 can optionally include wherein the operations further comprise training one or more machine learning models based on training data derived from the trip data, the one or more machine learning models used to analyze the trip data and determine one or more of the candidate popular trips, popular segments within the candidate popular trips, or the top-ranking waypoints; receiving new trip data; and retraining the one or more machine learning models using the new trip data.

Example 17 is a machine-storage medium storing instructions for providing popular route inference and reconstruction. The instructions configures one or more processors to perform operations comprising capturing trip data of a plurality of users traversing routes by monitoring user devices of the plurality of users; analyzing the trip data between an origin/destination (O/D) pair to determine candidate popular trips between the O/D pair comprising detours; determining top-ranking waypoints of segments of the candidate popular trips; storing the top-ranking waypoints of the O/D pair in a waypoint data storage; in response to receiving a request for a transportation service between the O/D pair from a user, reconstructing a popular route using the top-ranking waypoints; and causing presentation on a user device of the user of a plurality of route options for selection by the user, the plurality of route options including the reconstructed popular route.

In example 18, the subject matter of example 17 can optionally include wherein reconstructing the popular route comprises determining a primary route based on the request; identifying a candidate set of segments for detours that occur on the primary route; accessing waypoints associated with the candidate set of segments from the waypoint data storage; and ranking the accessed waypoints based on corresponding popularity scores to identify the top-ranking waypoints.

In example 19, the subject matter of any of examples 17-18 can optionally include wherein analyzing the trip data comprises generating segment detour popularity scores for segments of the O/D pair whereby the segments were traversed by not suggested for a trip; and generating a trip detour popularity score based on the segment detour popularity scores by applying a distance weighted average over the segments.

In example 20, the subject matter of any of examples 17-19 can optionally include wherein analyzing the trip data comprises joining matching detours to compute aggregated metrics, a segment being a matching detour when a threshold percentage of the segment matches a continuous stretch of a trajectory of a trip.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise. Furthermore, references to “top” can refer to “top-ranking” or “highest-scoring.”

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, components, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
capturing trip data of a plurality of users traversing routes by monitoring user devices of the plurality of users;
analyzing the trip data between an origin/destination (O/D) pair to determine candidate popular trips between the O/D pair comprising detours;
determining top-ranking waypoints of segments of the candidate popular trips;
storing the top-ranking waypoints of the O/D pair in a waypoint data storage;
in response to receiving a request for a transportation service between the O/D pair from a user, reconstructing a popular route using the top-ranking waypoints; and
causing presentation of on a user device of the user of a plurality of route options for selection by the user, the plurality of route options including the reconstructed popular route.

2. The method of claim 1, wherein analyzing the trip data comprises generating segment detour popularity scores for segments of the O/D pair whereby the segments were traversed by not suggested for a trip.

3. The method of claim 2, wherein analyzing the trip data comprises generating a trip detour popularity score based on the segment detour popularity scores by applying a distance weighted average over the segments.

4. The method of claim 1, wherein analyzing the trip data comprises joining matching detours to compute aggregated metrics, a segment being a matching detour when a threshold percentage of the segment matches a continuous stretch of a trajectory of a trip.

5. The method of claim 1, wherein determining the top-ranking waypoints comprises:
grouping different segments that represent the detours by divergence/convergence (D/C) hexagons, wherein the routes are converted to hexagons at a same level as the D/C hexagons;
aggregating metrics at a D/C level for each grouping of a detour; and
selecting a predetermined number of D/C segments for each detour based on the aggregated metrics.

6. The method of claim 5, wherein determining the top-ranking waypoints comprises:
extracting three waypoints for each selected D/C segment, the three waypoints comprising a waypoint at a middle of the detour, a waypoint in a beginning of the detour, and a waypoint towards an end of the detour; and
associating the aggregated metrics for their respective D/C segment to each waypoint, the top-ranking waypoints being based on the associated metrics.

7. The method of claim 1, wherein reconstructing the popular route comprises:
determining a primary route based on the request;
identifying a candidate set of segments for detours that occur on the primary route;
accessing waypoints associated with the candidate set of segments from the waypoint data storage; and
ranking the accessed waypoints based on corresponding popularity scores to identify the top-ranking waypoints.

8. The method of claim 1, further comprising:
training one or more machine learning models based on training data derived from the trip data, the one or more machine learning models used to analyze the trip data and determine one or more of the candidate popular trips, popular segments within the candidate popular trips, or the top-ranking waypoints;
receiving new trip data; and
retraining the one or more machine learning models using the new trip data.

9. A system comprising:
one or more hardware processors; and
memory storing instructions that, when executed by the one or more hardware processors, cause the one or more hardware processors to perform operations comprising:
capturing trip data of a plurality of users traversing routes by monitoring user devices of the plurality of users;
analyzing the trip data between an origin/destination (O/D) pair to determine candidate popular trips between the O/D pair comprising detours;
determining top-ranking waypoints of segments of the candidate popular trips;
storing the top-ranking waypoints of the O/D pair in a waypoint data storage;
in response to receiving a request for a transportation service between the O/D pair from a user, reconstructing a popular route using the top-ranking waypoints; and
causing presentation on a user device of the user of a plurality of route options for selection by the user, the plurality of route options including the reconstructed popular route.

10. The system of claim 9, wherein analyzing the trip data comprises generating segment detour popularity scores for segments of the O/D pair whereby the segments were traversed by not suggested for a trip.

11. The system of claim 10, wherein analyzing the trip data comprises generating a trip detour popularity score based on the segment detour popularity scores by applying a distance weighted average over the segments.

12. The system of claim 9, wherein analyzing the trip data comprises joining matching detours to compute aggregated metrics, a segment being a matching detour when a threshold percentage of the segment matches a continuous stretch of a trajectory of a trip.

13. The system of claim 9, wherein determining the top-ranking waypoints comprises:
grouping different segments that represent the detours by divergence/convergence (D/C) hexagons, wherein the routes are converted to hexagons at a same level as the D/C hexagons;
aggregating metrics at a D/C level for each grouping of a detour; and
selecting a predetermined number of D/C segments for each detour based on the aggregated metrics.

14. The system of claim 13, wherein determining the top-ranking waypoints comprises:
extracting three waypoints for each selected D/C segment, the three waypoints comprising a waypoint at a middle of the detour, a waypoint in a beginning of the detour, and a waypoint towards an end of the detour; and
associating the aggregated metrics for their respective D/C segment to each waypoint, the top-ranking waypoints being based on the associated metrics.

15. The system of claim 9, wherein reconstructing the popular route comprises:
determining a primary route based on the request;
identifying a candidate set of segments for detours that occur on the primary route;
accessing waypoints associated with the candidate set of segments from the waypoint data storage; and
ranking the accessed waypoints based on corresponding popularity scores to identify the top-ranking waypoints.

16. The system of claim 9, wherein the operations further comprise:
training one or more machine learning models based on training data derived from the trip data, the one or more machine learning models used to analyze the trip data and determine one or more of the candidate popular trips, popular segments within the candidate popular trips, or the top-ranking waypoints;
receiving new trip data; and
retraining the one or more machine learning models using the new trip data.

17. A machine-storage medium storing instructions that, when executed by one or more hardware processors of a machine, cause the machine to perform operations comprising:
capturing trip data of a plurality of users traversing routes by monitoring user devices of the plurality of users;
analyzing the trip data between an origin/destination (O/D) pair to determine candidate popular trips between the O/D pair comprising detours;
determining top-ranking waypoints of segments of the candidate popular trips;
storing the top-ranking waypoints of the O/D pair in a waypoint data storage;
in response to receiving a request for a transportation service between the O/D pair from a user, reconstructing a popular route using the top-ranking waypoints; and
causing presentation on a user device of the user of a plurality of route options for selection by the user, the plurality of route options including the reconstructed popular route.

18. The machine-storage medium of claim 17, wherein reconstructing the popular route comprises:
determining a primary route based on the request;
identifying a candidate set of segments for detours that occur on the primary route;
accessing waypoints associated with the candidate set of segments from the waypoint data storage; and
ranking the accessed waypoints based on corresponding popularity scores to identify the top-ranking waypoints.

19. The machine-storage medium of claim 17, wherein analyzing the trip data comprises:
generating segment detour popularity scores for segments of the O/D pair whereby the segments were traversed by not suggested for a trip; and
generating a trip detour popularity score based on the segment detour popularity scores by applying a distance weighted average over the segments.

20. The machine-storage medium of claim 17, wherein analyzing the trip data comprises joining matching detours to compute aggregated metrics, a segment being a matching detour when a threshold percentage of the segment matches a continuous stretch of a trajectory of a trip.
